(19) United States
(12) Patent Application Publication
(10) Pub. No.: US 2012/0062712 A1
(43) Pub. Date: Mar. 15, 2012

(54) DELIVERY OF DEVICE-SPECIFIC STEREO 3D CONTENT

(75) Inventors: Klaus Patrick Kesseler, Hamilton (CA); Roger Dass, Aurora (CA); Thomas F. El-Maraghi, Hawkestone (CA); Ihor Michael Petelycky, Toronto (CA)

(73) Assignee: SPATIAL VIEW INC., Toronto (CA)

(21) Appl. No.: 13/225,444

(22) Filed: Sep. 4, 2011

Related U.S. Application Data
(60) Provisional application No. 61/381,970, filed on Sep. 11, 2010.

(51) Int. Cl. H04N 13/04; H04N 13/00

(52) U.S. Cl. 348/56; 348/42; 348/E13.026

(57) ABSTRACT

Apparatus for delivery of stereo 3D content, including a library manager for retrieving, from a digital library of stereo 3D content, a version of a requested item of stereo 3D content stored in the library, on demand, a receiver, coupled with the library manager, for receiving, from a target device, a request for a desired item of stereo 3D content stored in the library, and an identification of display properties and stereo 3D characteristics of the target device, an adaptation engine, coupled with the receiver and with the library manager, for adapting the version of the item of stereo 3D content retrieved by the library manager, to an adapted version, optimized for viewing on the target device, based on the display properties and stereo 3D characteristics of the target device, and a transmitter, coupled with the adaptation engine, for transmitting the adapted version of the item of stereo 3D content to the target device, for download or for streaming. A system and a method are also described and claimed.

### CROSS REFERENCES TO RELATED APPLICATIONS

This application claims benefit of U.S. Provisional Application No. 61/381,970, entitled DELIVERY OF DEVICE-SPECIFIC STEREO 3D CONTENT, filed on Sep. 11, 2010 by inventors Klaus Patrick Kesseler, Roger Dass, Thomas El-Maraghi and Ihor Petelycky.

### FIELD OF THE INVENTION

The field of the present invention is stereo 3D imaging.

### BACKGROUND OF THE INVENTION

Today, most stereo 3D content is created for display on high-resolution large format displays, ranging from HD televisions with screen sizes on the order of 100 inches diagonal, to movie theater displays with screen sizes on the order of 40 ft.×70 ft. However, an increasing demand is evolving to view stereo content on mobile devices, such as laptops, portable game players, media players and smart phones. In 2010, Nintendo released a stereo 3D enabled gaming platform, and it is projected that by 2018 over 70 million mobile phones will be enabled for stereo 3D display.

There are many different stereo 3D viewing technologies available today. Some technologies, referred to as stereoscopic, require special viewing glasses. Examples of stereoscopic technologies include shutter and polarized displays. Other technologies, referred to as auto-stereoscopic, do not require special viewing glasses. Examples of auto-stereoscopic technologies include active and passive barrier, and lenticular overlay displays. Yet other technologies require special accessories such as 3D headgear and anaglyph glasses.

Conventional non-stereo image content delivered to mobile devices is adapted through scaling and color profile conversion, according to the display resolution and color profile of the target device. However, for stereo 3D content delivery, LCD display properties and stereo display characteristics of the target device have substantial effects on the quality of the 3D experience.

As such, it would be of advantage to be able to deliver stereo 3D content to many different target devices, adapted especially for optimal 3D experience on each target device.

### SUMMARY OF THE DESCRIPTION

Aspects of the present invention provide systems and methods to adapt stereo 3D content for delivery, by download or by streaming, from a central server computer to a variety of target devices, for optimal viewing experience on each target device. Embodiments of the present invention factor in display properties in conjunction with stereo 3D characteristics of a target device, to ensure that the version of stereo 3D content delivered to the target device maintains a high level of image and stereo 3D quality.

Using the present invention, a central server is able to store stereo 3D content in a standard format, and deliver the content, by download or by streaming, to a variety of different stereo 3D target devices, including inter alia devices with shutter and polarized displays, for viewing with glasses, devices with active barrier, passive barrier and lenticular overlays, for viewing without glasses, devices that are viewed with 3D headgear and anaglyph glasses, as well as stereo 3D displays that may be developed in the future. In accordance with an embodiment of the present invention, each target device informs the central server of its capabilities, or alternatively the target device capabilities are already stored on the central server, and the server adapts the content for optimal viewing on that device.

Further in accordance with embodiments of the present invention, the central server enforces copy protection. Each item of stereo 3D content is encrypted with a unique encryption key, and with a second key that incorporates an ID of the target device for which rendering of the content is authorized. Moreover, stereo 3D content stored on a target device is encrypted, and only decrypted during playback. As such, each item of stereo 3D content will only play on a device for which it is authorized. Thus, even if a key for one item of content is deciphered, the key will not work for any other item of content; and an unauthorized copy of an item of content is of no value to its recipient.

Yet further in accordance with an embodiment of the present invention, the central server operates cooperatively with a web store computer that manages subscriptions to and purchases of content. The central server retrieves from the web store lists of content available to a target device, and reports to the web store computer when an item of content is purchased for the target device.

There is thus provided in accordance with an embodiment of the present invention apparatus for delivery of stereo 3D content, including a library manager for retrieving, from a digital library of stereo 3D content, a version of a requested item of stereo 3D content stored in the library, on demand, a receiver, coupled with the library manager, for receiving, from a target device, a request for a desired item of stereo 3D content stored in the library, and an identification of display properties and stereo 3D characteristics of the target device, an adaptation engine, coupled with the receiver and with the library manager, for adapting the version of the item of stereo 3D content retrieved by the library manager, to an adapted version, optimized for viewing on the target device, based on the display properties and stereo 3D characteristics of the target device, and a transmitter, coupled with the adaptation engine, for transmitting the adapted version of the item of stereo 3D content to the target device, for download or for streaming.

There is additionally provided in accordance with an embodiment of the present invention a system for delivery of stereo 3D content, including a server computer including a library manager for retrieving, from a digital library of stereo 3D content, a version of a requested item of stereo 3D content stored in the library, on demand, a receiver, coupled with the library manager, for receiving, from a target device, a request for a desired item of stereo 3D content stored in the library, and an identification of display properties and stereo 3D characteristics of the target device, an adaptation engine, coupled with the receiver and with the library manager, for adapting a version of the item of stereo 3D content retrieved by the library manager, to an adapted version, optimized for viewing on the target device, based on the display properties and stereo 3D characteristics of the target device, and a transmitter, coupled with the adaptation engine, for transmitting the adapted version of the item of stereo 3D content to the target device, for download or for streaming, and a plurality of target devices, communicatively coupled with the server computer, each target device including a transmitter for transmitting, to the server computer, a request for a desired item of stereo 3D content stored in the library, and an identification of display properties and stereo 3D characteristics of the target client device, a receiver for receiving the adapted version of the item of stereo 3D content from the server computer transmitter, a display for displaying the received version of the item of stereo 3D content, for stereo 3D viewing, and a content player, coupled with the receiver, for rendering the received version of the item of stereo 3D content on the display.

There is further provided in accordance with an embodiment of the present invention a method for delivery of stereo 3D content, including receiving a request for a desired item of stereo 3D content, from a target device with stereo 3D content viewing capability, receiving, from the target device, an identification of display properties and 3D stereo characteristics of the target device, retrieving a version of the requested item of stereo 3D content from a stereo 3D content digital library, adapting the retrieved version of the item of stereo 3D content in accordance with the target device display properties and 3D stereo characteristics, and transmitting the adapted version of the item of stereo 3D content to the target device, for download or for streaming.

### BRIEF DESCRIPTION OF THE DRAWINGS

The present invention will be more fully understood and appreciated from the following detailed description, taken in conjunction with the drawings in which:

FIG. 1 is a simplified block diagram of a system for delivery of device-specific stereo 3D content from a central server to a plurality of target devices with different display properties and different stereo 3D characteristics, in accordance with an embodiment of the present invention;

FIG. 2 is a sample target device profile including display properties and stereo 3D characteristics, in accordance with an embodiment of the present invention;

FIG. 3 is a simplified block diagram of a central server computer for delivering stereo 3D content, and a generic target device for viewing stereo 3D content, in accordance with an embodiment of the present invention;

FIG. 4 is a simplified flowchart of a method for delivery of device-specific stereo 3D content from a central server to a plurality of target devices with different display properties and different stereo 3D characteristics, in accordance with an embodiment of the present invention;

FIG. 5 is a simplified flowchart of methods for interaction between a central server and a content web store, in accordance with an embodiment of the present invention;

FIG. 6 is a simplified flowchart of methods for interaction between a target device and a content web store, in accordance with an embodiment of the present invention; and

FIG. 7 is a simplified flowchart of a method for playback of stereoscopic 3D content on a target device, in accordance with an embodiment of the present invention.

### DETAILED DESCRIPTION

Aspects of the present invention relate to delivery of stereo 3D content on demand, by download or by streaming, to a variety of target devices with different stereo 3D capabilities, including inter alia devices with glasses-based shutter and polarized displays, devices with auto-stereoscopic active barrier, passive barrier and lenticular displays, devices that use 3D headgear and anaglyph glasses for viewing stereo 3D content, as well as stereo 3D displays that may be developed in the future.

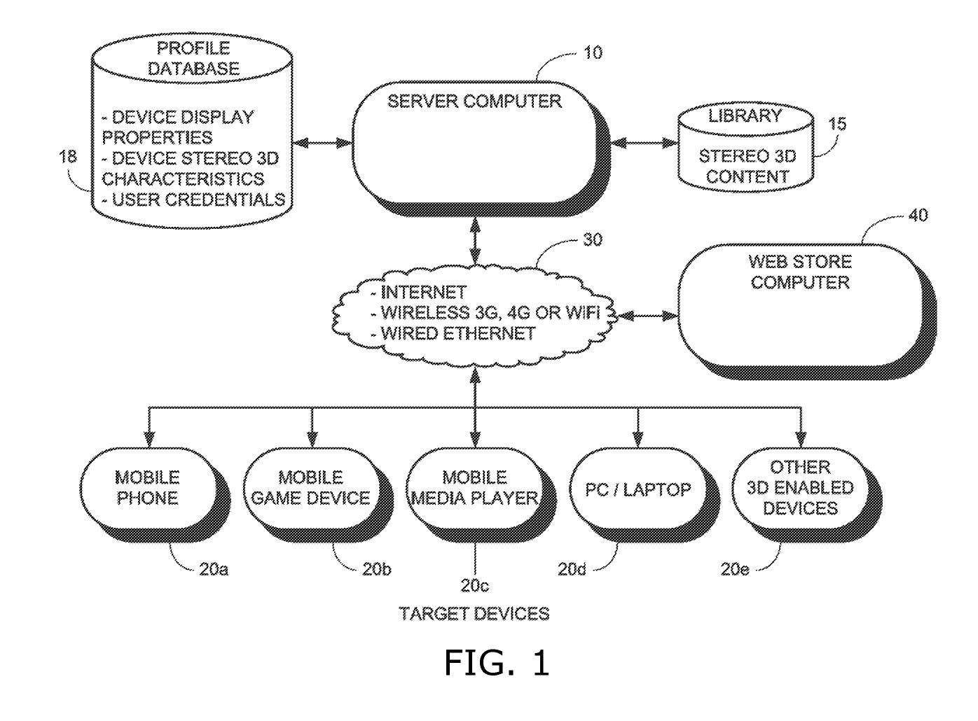

Reference is made to FIG. 1, which is a simplified block diagram of a system for delivery of device-specific stereo 3D content from a central server to a plurality of target devices with different display properties and different stereo 3D characteristics, in accordance with an embodiment of the present invention. Shown in FIG. 1 is a central server computer 10 that delivers stereo 3D content from a content library 15 to a variety of different target devices 20a-20e, over a communications network 30. Target devices 20a-20e include inter alia a mobile phone 20a, a mobile game device 20b, a mobile media player 20c, a desktop or laptop PC 20d, and other 3D enabled devices 20e.

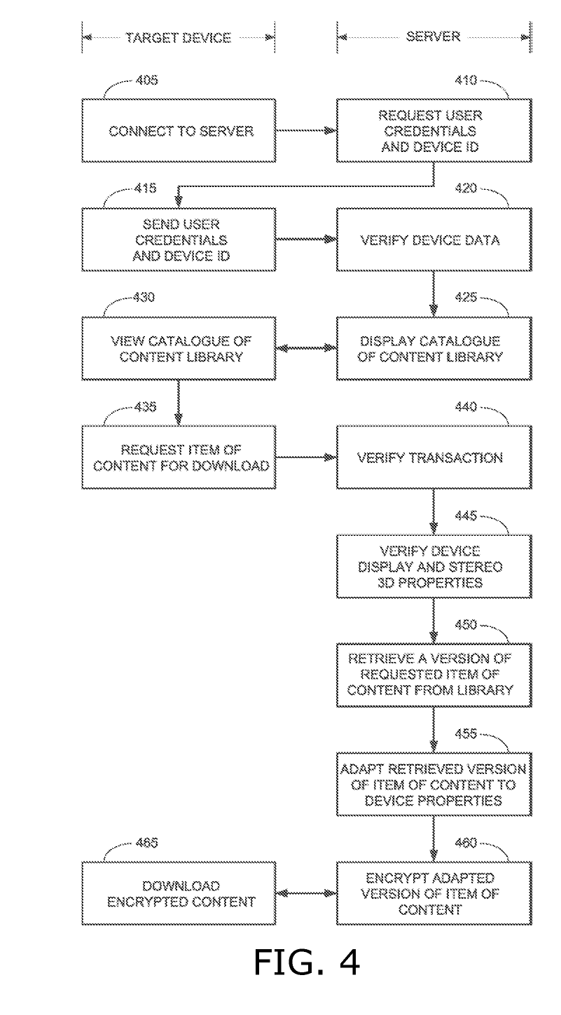

Server computer 10 is responsible for delivering stereo 3D content securely, on demand. Operation of server computer 10 is described hereinbelow with reference to FIG. 4.

Target devices 20a-20e generally have displays with different display properties, and support different stereo 3D rendering technologies and formats. Target devices 20a-20e may include inter alia devices with shutter and polarized displays, for viewing with glasses, devices with passive barrier and lenticular overlays, for viewing without glasses, and devices with displays that are viewed with 3D headgear and anaglyph glasses.

Target devices are categorized by device identifiers, which are used to determine the display properties and stereo 3D characteristics of the devices. A database 18 indexes different devices, their display properties and stereo 3D characteristics, referred to herein as their “profiles”, according to their identifiers. As such, when server 10 receives the identifier of a target device 20a-20e, it can retrieve the device's display properties and stereo 3D characteristics from database 18.

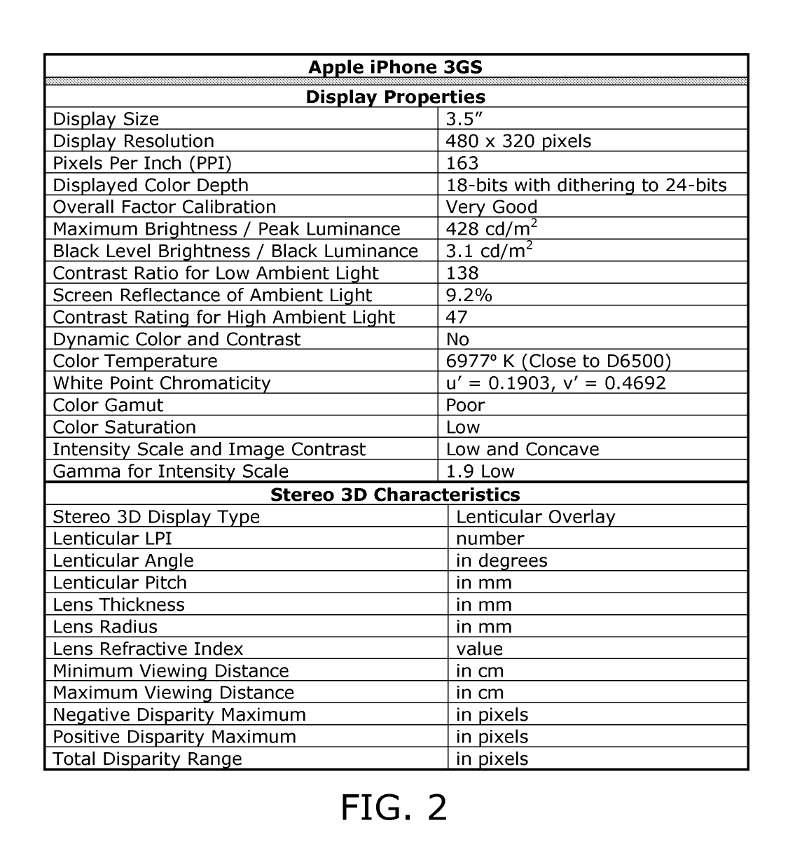

Reference is made to FIG. 2, which is a sample target device profile including display properties and stereo 3D characteristics for an Apple iPhone 3GS, in accordance with an embodiment of the present invention.

In an alternate embodiment of the present invention a target device descriptor is used to identify the device's display properties and stereo 3D characteristics, thereby obviating the need for database 18.

Communication between server 10 and target devices 20a-20e may be wired or wireless. Communications network 30 may be the Internet, or a wireless network including inter alia a 3G or a 4G or a WiFi network, or a wired network including inter alia an Ethernet network.

Also shown in FIG. 1 is a web store computer 40 that manages subscriptions to and purchases of content. Web store computer 40 may be embodied in one or more computers, which may or may not include server computer 10.

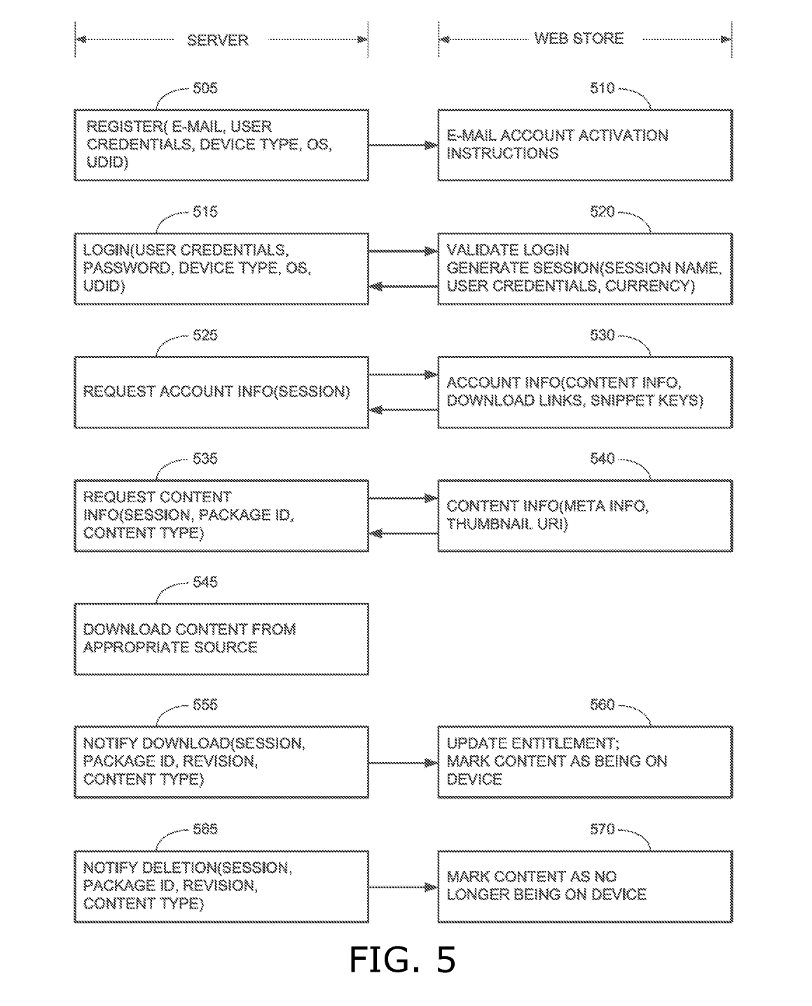

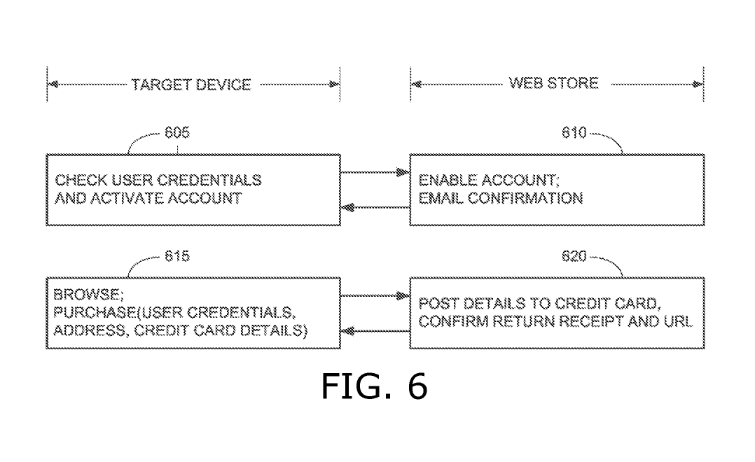

In one embodiment of the present invention, a user purchases entitlement packages from web store computer 40. The packages entitle the user to download content to one or more of his target devices. For example, the user may purchase a “1 mobile” package that includes (i) a primary content file for an iPhone 3D, (ii) a primary content file for an iPod Touch 2G, and (iii) a 3D preview file for the iPhone 3G. The “1 mobile” package entitles the user to download the primary content file to one mobile device. If the user wishes to download content to two mobile devices, then he may purchase a “2 mobile” package. Operation of web store computer 40 is described below with reference to FIGS. 5 and 6.

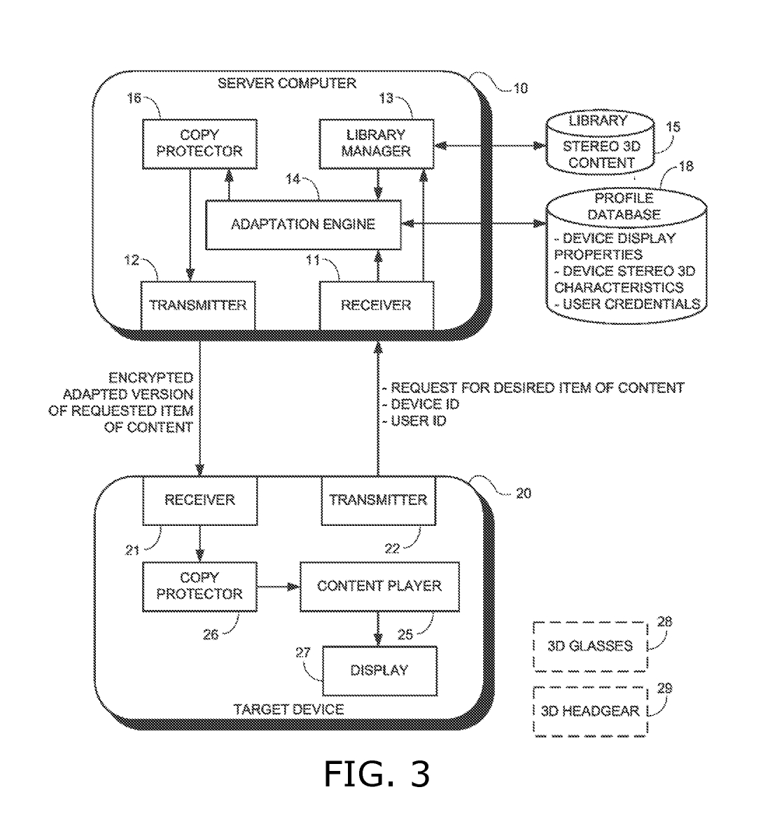

Reference is made to FIG. 3, which is a simplified block diagram of a central server computer 10 for delivering stereo 3D content, and a generic target device 20 for viewing the stereo 3D content, in accordance with an embodiment of the present invention. As shown in FIG. 3, target device 20 includes a content player 25, for rendering stereo 3D content on a display 27. Display 27 may be a shutter or polarized display, for viewing with 3D glasses 28. Display 27 may be a display with a passive barrier or lenticular overlay, for viewing without 3D glasses. Display 27 may be viewable using anaglyph glasses or 3D headgear 29. Display 27 may be capable of presenting several 3D modes, e.g., shutter, anaglyph and lenticular.

As shown in FIG. 3, server computer 10 includes a receiver 11 for receiving a request for a desired item of stereo 3D content that is stored in library 15, and for receiving user credentials and a device identifier of target device 20, from a transmitter 22 of target device 20. The device identifier is used to retrieve display properties and stereo 3D characteristics of the device. The user credentials are used to authenticate a user. Server computer 10 further includes a transmitter 12 for transmitting an adapted version of the requested item of stereo 3D content to a receiver 21 of client device 20.

Server computer 10 includes a library manager 13 for accessing items stereo 3D content that are stored in library 15. The library itself, may reside on one or more computers, including or not including server computer 10. Library manager 13 receives the request for the item of stereo 3D content from receiver 11, and retrieves a version of the requested item of stereo 3D content from library 15. The version of the requested item of stereo 3D content retrieved from library 15 may not be compatible for target device 20. As such, library manager 13 passes the retrieved version of the item of stereo 3D content to an adaptation engine 14.

Adaptation engine 14 receives the target device ID from receiver 11, retrieves the target device display properties and stereo 3D characteristics from database 18, and adapts the version of the requested content retrieved from library 15 accordingly. Details of operation of adaptation engine 14 are described hereinbelow.

In accordance with an embodiment of the present invention, central server 10 includes a copy protector 16 for enforcing copy protection. Copy protector 16 encrypts each item of content with a unique encryption key, and with a second key that incorporates a unique ID of target device 20.

Correspondingly, target device 20 includes a copy protector 26 for decrypting encrypted content. In accordance with an embodiment of the present invention, content stored on target device 20 is only decrypted during playback. As such, each item of content will only play on a device for which it is authorized. Thus, even if a key for one item of content is deciphered, the key will not work for any other item of content; and an unauthorized copy of an item of content is of no value to its recipient.

Reference is made to FIG. 4, which is a simplified flowchart of a method for delivery of device-specific stereo 3D content from a central server to a plurality of target devices with different display properties and different stereo 3D characteristics, in accordance with an embodiment of the present invention. The flowchart of FIG. 4 is divided into two columns; namely, a left column showing steps performed by a target device, such as any of target devices 20a-20e, and a right column showing steps performed by a central server computer, such as server computer 10.

At step 405 the target device connects to the server computer. At step 410 the server computer requests user credentials and a device ID from the target device. In accordance with an embodiment of the present invention, each target device category has a unique device profile. Further, each user and device has a unique profile. The device ID is first created by the target device and transmitted to the server, when the target device registers itself with the server.

At step 415 the target device sends user credentials and a device ID to the server computer. At step 420 the server computer verifies the data that it received from the target device at step 415. If the verification fails, then an error is indicated and the login fails. If the verification succeeds, then at step 425 the server computer displays a library catalogue of stereo 3D content to the target device. The catalogue may be device-specific or platform-specific.

At step 430 the target device interactively views the library catalogue. At step 435 the target device requests a desired item of content for download. At step 440 the server computer verifies the transaction for the requested content. If the verification fails, then the transaction is aborted. If the verification succeeds, then at step 445 the server computer retrieves display properties and stereo 3D properties of the target device, based on the device ID.

At step 450 the server computer retrieves from the digital library a version of the item of stereo 3D content that was requested by the target device at step 435. At step 455 the server computer adapts the version, as required, for the target device. Adaptations performed at step 455 include two types of processing; namely, general display adaptations and stereo 3D adaptations.

General adaptations include inter alia
adjustments for target device color profile;
adjustments for target device contrast ratio;
adjustments for brightness and contrast; and
adjustments for target device aspect ratio.

Stereo 3D adaptations include inter alia
generation of a disparity map;
correction for occlusions;
storing the disparity map with the content;
scaling the content based on the current content disparity vis-à-vis the target device disparity profile;
corrections for rectification and alignment; and
on-the-fly changes during streaming according to user preferences, e.g., when a user modifies a depth slider control on the target device.

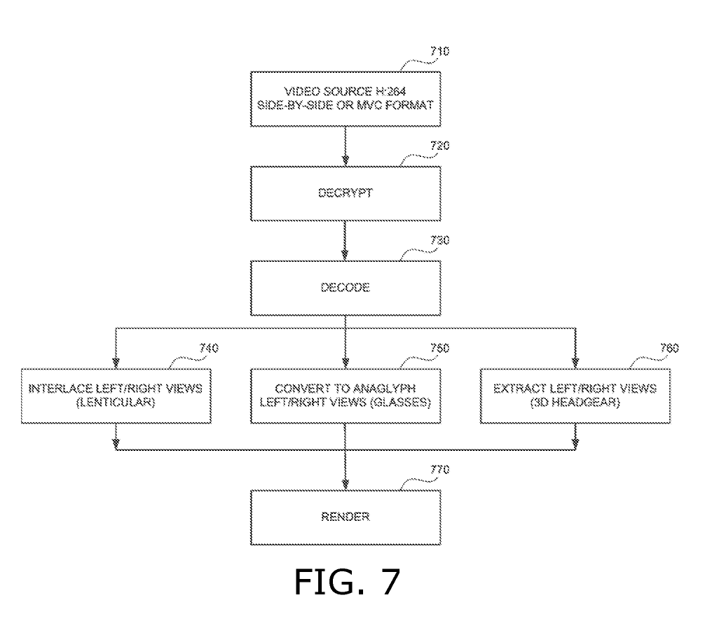

At step 460 the server computer encrypts the adapted version of the item of content. Finally, at step 465 the target device downloads the encrypted item of content. Playback of the downloaded content on the target device is described hereinbelow with reference to FIG. 7.

The target device may then terminate the session and view the downloaded item of content locally, or return to step 435 to request one or more additional items of content from the server computer. In an alternate embodiment of the present invention, the server computer streams the adapted version of the content to the target device, for on-line viewing.

It will thus be appreciated by those skilled in the art that embodiments of the present invention obviate the need to store many different versions of items of stereo 3D content in order to accommodate a wide variety of target devices with different display and stereo 3D profiles. Instead, the flowchart of FIG. 4 (i) retrieves a first version of an item of content, requested by a target device, from a stereo 3D content library, (ii) adapts the first version to a second version, especially optimized for the display and stereo 3D profile of the target device, and (iii) encrypts the second version to a third encrypted version for security.

Reference is made to FIG. 5, which is a simplified flowchart of methods for interaction between a central server and a content web store, in accordance with an embodiment of the present invention. The flowchart of FIG. 5 is divided into two columns; namely, a left column showing steps performed by central server computer, such as server computer 10, and a right column showing steps performed by a web store computer, such as web store computer 40.

Steps 505 and 510 are a method of registration, in accordance with an embodiment of the present invention. At step 505 the server computer sends a registration request to the web store computer, on behalf of a target device, with parameters describing the target device. The parameters include inter alia an e-mail address, user credentials, a device type, an operating system and a unique device identifier. At step 510 the web store computer activates an account for the target device, and sends an e-mail to the target device with account activation instructions.

Steps 515 and 520 are a method of login, in accordance with an embodiment of the present invention. At step 515 the server computer logs in to the web store computer on behalf of a target device, with login parameters that include inter alia user credentials, a password, a device type, an operating system and a unique device identifier. At step 520 the web store computer validates the login, generates a session, and returns parameters that include inter alia a session name, user credentials and a currency.

Steps 525 and 530 are a method of requesting account information, in accordance with an embodiment of the present invention. At step 525 the server computer issues a request for account information for the target device, with a session parameter. At step 530 the web store computer determines a list of content that the target device may download. In one embodiment of the present invention, the list of content is based on entitlements that were purchased, and based on the target device type.

Content may be invalidated at step 530. Referring to the example above, a user may purchase an entitlement for a “1 mobile” package, that entitles him to (i) a primary content file for an iPhone 3G, (ii) a primary content file for an iPod Touch 2G, and (iii) a 3D preview file for the iPhone 3G. When the user's iPhone 3G target device is running on the server computer, the web store computer will filter content based on the “1 mobile package” and the device type. The list determined at step 530 would then include the primary content file for the iPhone 3G and a 3D display type.

After determining the list of content, the web store computer sends inter alia content information, download links, and snippet keys to the server computer.

Steps 535 and 540 are a method of requesting content information, in accordance with an embodiment of the present invention. At step 535 the server computer requests from the web store computer information about a designated item of content, and sends parameters including inter alia a session, a package identifier, and a content type. At step 540 the web store computer retrieves the content metadata including inter alia a title, a description, a price a genre, and one or more thumbnails. The web store computer returns the metadata and one or more thumbnail URI's to the server computer.

Step 545 is a method for downloading a designated item of content, in accordance with an embodiment of the present invention. At step 545 the server computer downloads the content from an appropriate source. In one embodiment of the present invention, the content is downloaded from an Amazon CLOUDFRONT™ computer.

Steps 555 and 560 are a method for notification of download of an item of content, in accordance with an embodiment of the present invention. When an item of content is downloaded at step 545, the server computer notifies the web store that it has successfully downloaded the file. The web store then associates the entitlement to that device. Referring to the “1 mobile” example hereinabove, when a second target device is running, the list of content determined at step 530 will no longer include that item of content. If the user had purchased a “2 mobile” package instead of the “1 mobile” package, then the list of content for the second target device would include that item of content, but not for a third target device.

At step 560 the web store computer updates the entitlement counts, and marks the item of content as being resident on the target device.

Steps 565 and 570 are a method for deletion of an item of content, in accordance with an embodiment of the present invention. At step 565, the server computer notifies the web store computer that the target device has deleted an item of content. At step 570 the web store computer marks the content as no longer being resident on the target device, and updates the entitlement counts accordingly. Referring to the “1 mobile” example hereinabove, if an item of content is deleted from a first target device, then the list of content determined at step 530 for a second target device will include that item of content.

Reference is made to FIG. 6, which is a simplified flowchart of methods for interaction between a target device and a content web store, in accordance with an embodiment of the present invention. The flowchart of FIG. 6 is divided into two columns; namely, a left column showing steps performed by a target device, such as any of target devices 20a-20e, and a right column showing steps performed by a web store computer, such as web store computer 40.

Steps 605 and 610 are a method for account activation, in accordance with an embodiment of the present invention. At step 605 a target device receives the e-mail notification sent by the web store computer at step 510. The target device follows the e-mail instructions and activates the account. At step 610 the web store computer enables the account and sends an e-mail confirmation to the target device.

Steps 615 and 620 are a method for browsing and purchasing an item of content, in accordance with an embodiment of the present invention. At step 615 the target device browses the web store computer, and purchases a package such as the exemplary “1 mobile” package described hereinabove. The purchase instruction is sent to the web store computer with parameters including inter alia user credentials, an address and credit card details. At step 620 the web store computer processes the purchase request, posts details of the request with a credit card transaction processor, and returns a confirmation with a URL to the target device.

Reference is made to FIG. 7, which is a simplified flowchart of a method for playback of stereoscopic 3D content on a target device, in accordance with an embodiment of the present invention. In general, a target device may have different 3D rendering options based on stereoscopic display type. E.g., an IPOD®, manufactured by Apple, Inc. of Cupertino, Calif., may use a lenticular overlay, or anaglyph glasses or 3D headgear.

At step 710 a target device receives encrypted content, as in step 465 of FIG. 4. The content may be, for example, an H:264 video source in side-by-side or mufti-view coding (MVC) stereo 3D format. At step 720 the target device decrypts the content, and at step 730 the target device decodes the decrypted content.

Subsequently, the method proceeds to step 740 if the target device has a lenticular overlay on its display, to step 750 if anaglyph glasses are used to view the target device display in stereo, and to step 760 if 3D headgear is used to view the target device display in stereo. At step 740 left and right views of the decoded content are interlaced. At step 750 the decoded content is converted to anaglyph left/right views. At step 760 left and right views are extracted from the decoded content. Finally, at step 770 the content prepared at step 740 or step 750 or step 760, is rendered on the target device for stereo 3D viewing.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. Apparatus for delivery of stereo 3D content, comprising:
a library manager for retrieving, from a digital library of stereo 3D content, a version of a requested item of stereo 3D content stored in the library, on demand;
a receiver, coupled with said library manager, for receiving, from a target device, a request for a desired item of stereo 3D content stored in the library, and an identification of display properties and stereo 3D characteristics of the target device;
an adaptation engine, coupled with said receiver and with said library manager, for adapting the version of the item of stereo 3D content retrieved by said library manager, to an adapted version, optimized for viewing on the target device, based on the display properties and stereo 3D characteristics of the target device; and
a transmitter, coupled with said adaptation engine, for transmitting the adapted version of the item of stereo 3D content to the target device, for download or for streaming.

2. The apparatus of claim 1 wherein said adaptation engine retrieves the display properties and stereo 3D characteristics of the target device from a profile database, based on the identification received by said receiver.

3. The apparatus of claim 1 wherein said server computer further comprises a copy protector, coupled with said adaptation engine and said transmitter, for encrypting the adapted version of the item of stereo 3D content generated by said adaptation engine, and wherein said transmitter transmits the encrypted version of the desired content to the target device.

4. The apparatus of claim 1 wherein said adaptation engine adapts the retrieved version of the item of stereo 3D content for maximum and minimum disparity.

5. The apparatus of claim 1 wherein said adaptation engine generates a disparity map or a depth map.

6. The apparatus of claim 5 wherein said adaptation engine stores the disparity map or the depth map with the adapted version of the item of stereo 3D content.

7. The apparatus of claim 1 wherein said adaptation engine corrects the retrieved version of the item of stereo 3D content for occlusions.

8. The apparatus of claim 1 wherein said adaptation engine scales the retrieved version of the item of stereo 3D content based on a disparity profile of the target device.

9. A system for delivery of stereo 3D content, comprising:
a server computer comprising:
a library manager for retrieving, from a digital library of stereo 3D content, a version of a requested item of stereo 3D content stored in the library, on demand;
a receiver, coupled with said library manager, for receiving, from a target device, a request for a desired item of stereo 3D content stored in the library, and an identification of display properties and stereo 3D characteristics of the target device;
an adaptation engine, coupled with said receiver and with said library manager, for adapting a version of the item of stereo 3D content retrieved by said library manager, to an adapted version, optimized for viewing on the target device, based on the display properties and stereo 3D characteristics of the target device; and
a transmitter, coupled with said adaptation engine, for transmitting the adapted version of the item of stereo 3D content to the target device, for download or for streaming; and
a plurality of target devices, communicatively coupled with said server computer, each target device comprising:
a transmitter for transmitting, to said server computer, a request for a desired item of stereo 3D content stored in the library, and an identification of display properties and stereo 3D characteristics of the target client device;
a receiver for receiving the adapted version of the item of stereo 3D content from said server computer transmitter;
a display for displaying the received version of the item of stereo 3D content, for stereo 3D viewing; and
a content player, coupled with said receiver, for rendering the received version of the item of stereo 3D content on said display.

10. The system of claim 9 wherein said target device receiver receives an encrypted version of the item of stereo 3D content, and wherein said target device further comprises a copy protector, coupled with said target device receiver and with said content player, for decrypting the encrypted version of the item of stereo 3D content.

11. The system of claim 9 wherein at least one target device display comprises a shutter display, the system further comprising shutter glasses for viewing said shutter display.

12. The system of claim 9 wherein at least one target device display comprises a polarized display, the system further comprising polarized glasses for viewing said polarized display.

13. The system of claim 9 wherein at least one target device display comprises a display with a passive barrier or an active barrier.

14. The system of claim 9 further comprising a lenticular lens for at least one target device display.

15. The system of claim 9 further comprising 3D headgear for viewing content displayed on at least one target device display.

16. The system of claim 9 further comprising anaglyph glasses for viewing content displayed on at least one target device display.

17. The system of claim 9 further comprising a web store computer, communicatively coupled with said plurality of target devices, for managing a plurality of entitlement packages for said plurality of target devices, respectively, the entitlement packages governing which items of stereo 3D content stored in the library may be requested by any one of the plurality of target devices.

18. The system of claim 17 wherein said web store computer is also communicatively coupled with said server computer, and wherein said server computer transmitter transmits, to a target device, a list of the stereo 3D content that is available for download by the target device, based on the entitlement package for the target device.

19. A method for delivery of stereo 3D content, comprising:
receiving a request for a desired item of stereo 3D content, from a target device with stereo 3D content viewing capability;
receiving, from the target device, an identification of display properties and 3D stereo characteristics of the target device;
retrieving a version of the requested item of stereo 3D content from a stereo 3D content digital library;
adapting the retrieved version of the item of stereo 3D content in accordance with the target device display properties and 3D stereo characteristics; and
transmitting the adapted version of the item of stereo 3D content to the target device, for download or for streaming.

20. The method of claim 19 further comprising encrypting the adapted version of the item of stereo 3D content, and wherein said transmitting transmits the encrypted version of the item of stereo 3D content.

21. The method of claim 19 wherein said receiving an identification comprises receiving a client ID, the method further comprising retrieving the display properties and stereo 3D characteristics from a database of profiles indexed by client IDs.

22. The method of claim 19 wherein the stereo 3D content viewing capability of the target device comprises a shutter display, and shutter glasses for viewing the adapted item of stereo 3D content displayed thereon.

23. The method of claim 19 wherein the stereo 3D content viewing capability of the target device comprises a polarized display, and polarized glasses for viewing the adapted item of stereo 3D content displayed thereon.

24. The method of claim 19 wherein the stereo 3D content viewing capability of the target device comprises a display with an active or a passive barrier.

25. The method of claim 19 wherein the stereo 3D content viewing capability of the target device comprises a display with a lenticular lens.

26. The method of claim 19 wherein the stereo 3D content viewing capability of the target device comprises 3D headgear for viewing the adapted item of stereo 3D content.

27. The method of claim 19 wherein the stereo 3D content viewing capability of the target device comprises anaglyph glasses for viewing the adapted item of stereo 3D content.

28. The method of claim 19 wherein said adapting comprises adapting the retrieved version of the item of stereo 3D content for maximum and minimum disparity.

29. The method of claim 19 wherein said adapting comprises generating a disparity map or a depth map.

30. The method of claim 29 wherein said adapting comprises storing the disparity map or the depth map with the adapted version of the requested content.

31. The method of claim 19 wherein said adapting comprises correcting the retrieved version of the item of stereo 3D content for occlusions.

32. The method of claim 19 wherein said adapting comprises scaling the retrieved version of the item of stereo 3D content based on a disparity profile or a depth map profile of the target device.
